(19) United States
(12) Patent Application Publication
(10) Pub. No.: US 2017/0312857 A1
(43) Pub. Date: Nov. 2, 2017

(54) METHODS OF ADDITIVE MANUFACTURING

(71) Applicant: Board of Regents, The University of Texas System, Austin, TX (US)

(72) Inventors: David Bourell, Sunset Valley, TX (US); Christopher Roberts, Austin, TX (US); Julien Cohen, Austin, TX (US)

(21) Appl. No.: 15/144,483

(22) Filed: May 2, 2016

(51) Int. Cl. B23K 26/342; B22F 1/00; C22C 21/08; C22F 1/047; B23K 103/10; B33Y 70/00; B33Y 10/00

(52) U.S. Cl. CPC B23K 26/342; C22C 21/08; B22F 1/0003; C22F 1/047; B33Y 70/00; B22F 2301/052; B33Y 10/00; B23K 2203/10; B22F 2304/10

(57) ABSTRACT

Methods of producing three-dimensional alloy workpieces are described herein, which can comprise: producing a precursor workpiece on a layer-by-layer basis by depositing a layer of a mixed powder, the mixed powder comprising an elemental powder and a second powder; melting at least a portion of the elemental powder by directing an energy field onto a portion of the layer; and repeating the deposing and melting steps to form the precursor workpiece from a plurality of layers. The precursor workpiece can comprise a dispersed phase and a continuous phase, the dispersed phase being dispersed within the continuous phase, the dispersed phase comprising a plurality of discrete regions comprising the second powder, and the continuous phase comprising the melted elemental powder. The methods can further comprise heating the precursor workpiece to homogenize the continuous phase and the dispersed phase, thereby forming the three-dimensional alloy workpiece comprising a continuous alloy phase.

### BACKGROUND

Aluminum alloy 6061, composed of aluminum with approximately 1% magnesium, 0.6% silicon, and trace amounts of copper and chromium, is widely used throughout industry including aerospace and marine sectors due to its acceptable weldability and excellent corrosion resistance. Since this alloy has been approved for safety critical applications, commercial interest is high in developing an approach to additive manufacturing (AM) of this alloy.

Currently AlSi10Mg, closely related to the aluminum casting grade A360, is the most popular alloy for selective laser melting (SLM); the aluminum silicon system exhibits high fluidity and low shrinkage leading to its use in casting, brazing and welding applications. When present in significant quantities, as in AlSi10Mg, silicon decreases the melting range of the of the alloy and increases hot tearing resistance without introducing brittleness. By decreasing the melt range, dendritic cooling and shrinkage in the mushy zone can be reduced prior to full solidification, which can lead to decreased void generation and hot tearing.

However, unlike AlSi10Mg, AA6061 belongs to the wrought class of aluminum alloys. Low silicon content and large shrinkage can inhibit many of the advantageous properties associated with the aluminum silicon casting series. Data provided by ASM (2002) Al-303 and Al-308 show that hypoeutectic AA6061 possesses a freezing range of approximately 70 K (verses 20 K for A360), resulting in increased hot tearing, especially during the highly non-equilibrium processes observed during selective laser melting. Furthermore, the rapid formation of an oxide layer, high solubility limit of hydrogen, and high thermal conductivity and thermal expansion coefficient of aluminum present several technical challenges when processing these alloys. Thus, much of the research into processing off-eutectic aluminum alloys and AA6061 in particular, has shown unacceptable levels of cracking, highly anisotropic microstructures, and porosity (Benjamin F A et al. SFF Symposium Proceedings. Austin, 2014, 404-419; Louvis E et al. J. Mater. Process. Technol. 2011, 211, 275-284). A challenge for additive manufacturing with regard to materials is developing consistent quality parts in a wider variety of materials. Therefore, it is of great research and industrial interest to determine new approaches for processing off-eutectic alloys not suitable to traditional additive manufacturing approaches. The methods discussed herein address these and other needs.

### SUMMARY

Disclosed herein are method of producing three-dimensional alloy workpieces. The methods can comprise, for example, producing a precursor workpiece on a layer-by-layer basis by depositing a layer of a mixed powder, the mixed powder comprising an elemental powder and a second powder. The method can, in some examples, further comprise forming the mixed powder. The mixed powder can be formed, for example, by mixing the elemental powder and the second powder.

In some examples, the elemental powder can be present in the mixed powder in an amount of 50% or more by weight (e.g., 99% or more). The elemental powder can comprise, for example, a metallic element in commercial purity. In some examples, the elemental powder can comprise a metallic element with an elemental purity of 99% or more. The elemental powder can, for example, comprise a plurality of particles having an average particle size of from 5 μm to 100 μm.

The elemental powder can, in some examples, comprise a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, and Yb. In some examples, the elemental powder can comprise a metal selected from the group consisting of Mg, Al, Ti, Fe, Ni, Cu, Zn, and Pb. In some examples, the elemental powder can consist of a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, and Yb. In some examples, the elemental powder can consist of a metal selected from the group consisting of Mg, Al, Ti, Fe, Ni, Cu, Zn, and Pb. The elemental powder can, for example, consist essentially of a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, and Yb. In some examples, the elemental powder can consist essentially of a metal selected from the group consisting of Mg, Al, Ti, Fe, Ni, Cu, Zn, and Pb.

The second powder can, for example, comprise a metal, a semimetal, a nonmetal, or a combination thereof. The second powder can, for example, comprise a plurality of particles having an average particle size of from 5 μm to 100 μm. In some examples, the second powder can comprise Be, B, C, Mg, Al, Si, P, S, Ca, Sc, Ti, V, Cr, Mn, Fe, Co, Ni, Cu, Zn, Ga, Ge, As, Se, Sr, Y, Zr, Nb, Mo, Tc, Ru, Rh, Pd, Ag, Cd, In, Sn, Sb, Te, Ba, Hf, Ta, W, Re, Os, Ir, Pt, Au, Hg, Tl, Pb, Bi, Po, La, Ce, Pr, Nd, Pm, Sm, Eu, Gd, Tb, Dy, Ho, Er, Tm, Yb, or a combination thereof. In some examples, the second powder can comprise a second elemental powder. In some example, the second elemental powder can have an elemental purity of 99% or more.

In some examples, producing the precursor workpiece on a layer-by-layer basis can further comprise melting at least a portion of the elemental powder in the layer by directing an energy field onto a portion of the layer of the mixed powder. In some examples, the energy field can comprise an energy beam (e.g., a laser beam).

Producing the precursor workpiece on a layer-by-layer basis can further comprise repeating the deposing and melting steps to form the precursor workpiece from a plurality of layers. The precursor workpiece can, for example, comprise a dispersed phase and a continuous phase, the dispersed phase being dispersed within the continuous phase, the dispersed phase comprising a plurality of discrete regions comprising the second powder, and the continuous phase comprising the melted elemental powder.

In some examples, the methods can further comprise heating the precursor workpiece to homogenize the continuous phase and the dispersed phase, thereby forming the three-dimensional alloy workpiece comprising a continuous alloy phase. Heating the precursor workpiece can, for example, comprise heating at a temperature of from 50° C. to 800° C. (e.g., from 150° C. to 500° C.). The precursor workpiece can be heated, for example, for an amount of time of from 10 minutes to 2 hours (e.g., from 20 minutes to 1 hour).

The continuous alloy phase can, for example, comprise an aluminum alloy, a copper alloy, a titanium alloy, a magnesium alloy, a nickel alloy, a lead alloy, a zinc alloy, a stainless steel alloy, or a combination thereof. In some examples, the continuous alloy phase can comprise an off-eutectic alloy.

Additional advantages will be set forth in part in the description that follows or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1 is a secondary electron image of aluminum powder sourced from Valimet showing substantially spherical morphology.

FIG. 2 is a secondary electron image fine silicon powder characterized by faceted surfaces.

FIG. 3 shows the shear cell testing results comparing the elemental mixture to commercially available additive manufacturing feedstock.

FIG. 4 shows the sample geometry for AA6061 and Al—Si additive manufacturing builds. Dimensions are in mm.

FIG. 5 is an optical microscope image of selective laser melting processed AA6061 (343 W, 752 mm/s, 0.13 mm scan spacing) showing evidence of solidification cracking starting approximately 0.75 mm above the support structure. “BD” is the build (+Z) direction.

FIG. 6 is a SEM image of dark pools resulting from the segregation of magnesium.

FIG. 7 shows the surface of elemental Al—Si Specimen 1 (313 W, 750 mm/s), indicating minimal surface cracking or porosity.

FIG. 8 shows an image of Sample 12 (319 W, 375 mm/s). Large porous voids are visible along with lines of smaller porosity emanating from the support structure legs.

FIG. 9 shows an image of Sample 9 (284 W, 544 mm/s) showed significantly less porosity leading to an acceptable density.

FIG. 10 shows the as processed AA6061 sample.

FIG. 11 shows the as processed Al—Si mixture.

FIG. 12 is a SEM image illustrating the silicon particle location. The larger of the two silicon particles shown in the image measured 4.53 μm along the major axis. Silicon rich regions appear as dark features.

FIG. 13 is an EDS Si elemental map of SEM image in FIG. 12 illustrating the silicon particle location. The larger of the two silicon particles shown in the image measured 4.53 μm along the major axis. Silicon rich regions appear as dark features

FIG. 14 shows the as built Al—Si elemental mix after selective laser melting but before post processing. Silicon rich regions appear as dark features.

FIG. 15 shows the as built Al—Si elemental mix after selective laser melting and after post processing. Silicon rich regions appear as dark features. It can be seen that both the number and size of the particles have been greatly reduced after heat treatment. However, one particle is still present in the heat treated sample.

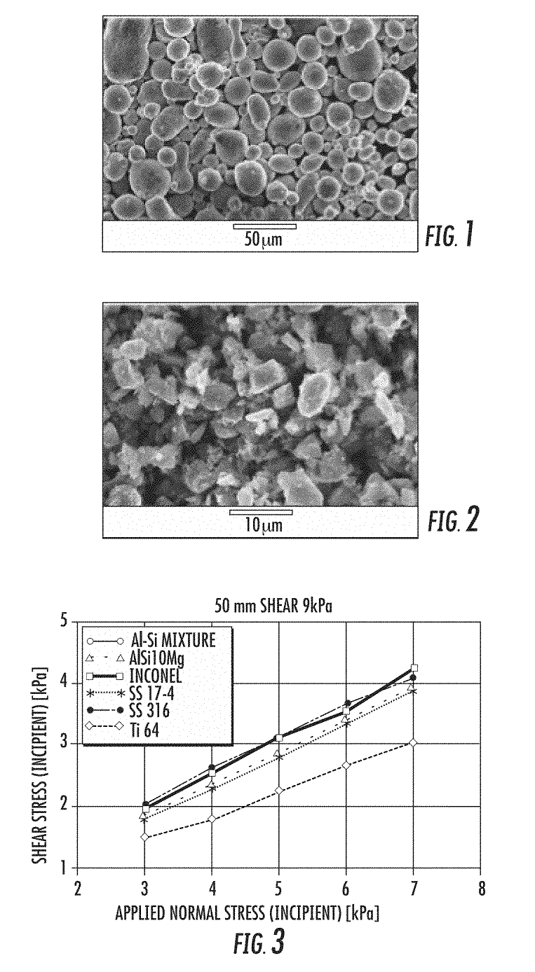

### DETAILED DESCRIPTION

The methods described herein may be understood more readily by reference to the following detailed description of specific aspects of the disclosed subject matter and the Examples included therein.

Before the present methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid the reader in distinguishing the various components, features, or steps of the disclosed subject matter. The identifiers “first” and “second” are not intended to imply any particular order, amount, preference, or importance to the components or steps modified by these terms.

Disclosed herein are method of producing three-dimensional alloy workpieces. The method can comprise, for example, producing a precursor workpiece on a layer-by-layer basis by depositing a layer of a mixed powder, the mixed powder comprising an elemental powder and a second powder.

In some examples, the elemental powder can be present in the mixed powder in an amount of 50% or more by weight (e.g., 55% or more, 60% or more, 65% or more, 70% or more, 75% or more, 80% or more, 85% or more, 90% or more, or 95% or more). In some examples, the elemental powder cab be present in the mixed powder in an amount of 99% or more (e.g., 99.1% or more, 99.2% or more, 99.3% or more, 99.4% or more, 99.5% or more, 99.6% or more, 99.7% or more, 99.8% or more, or 99.9% or more).

The elemental powder can comprise, for example, a metallic element in commercial purity. In some examples, the elemental powder can comprise a metallic element with an elemental purity of 99% or more (e.g., 99.1% or more, 99.2% or more, 99.3% or more, 99.4% or more, 99.5% or more, 99.6% or more, 99.7% or more, 99.8% or more, or 99.9% or more).

The elemental powder can, in some examples, comprise a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, and Yb. In some examples, the elemental powder can comprise a metal selected from the group consisting of Mg, Al, Ti, Fe, Ni, Cu, Zn, and Pb.

In some examples, the elemental powder can consist of a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, and Yb. In some examples, the elemental powder can consist of a metal selected from the group consisting of Mg, Al, Ti, Fe, Ni, Cu, Zn, and Pb.

The elemental powder can, for example, consist essentially of a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, and Yb. In some examples, the elemental powder can consist essentially of a metal selected from the group consisting of Mg, Al, Ti, Fe, Ni, Cu, Zn, and Pb.

The elemental powder can, for example, comprise a plurality of particles having an average particle size. “Average particle size,” “mean particle size,” and “median particle size” are used interchangeably herein, and generally refer to the statistical mean particle size of the particles in a population of particles. For example, the average particle size for a plurality of particles with a substantially spherical shape can comprise the average diameter of the plurality of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. For a non-spherical particle, the average particle size can refer to, for example, the average maximum dimension of the particle (e.g., the length of a rod shaped particle, the diagonal of a cube shape particle, the bisector of a triangular shaped particle, etc.) For a non-spherical particle, the average particle size can refer to, for example, the hydrodynamic size of the particle. Mean particle size can be measured using methods known in the art, such as evaluation by scanning electron microscopy, transmission electron microscopy, optical microscopy, screening, sedimentation, conductivity, laser diffraction, and/or dynamic light scattering. The mean particle size can refer to the number average particle size, the mass average particle size, or the volume average particle size, as known in the art. The number average particle size can be converted to the mass average particle size and/or the volume average particle size using known methods (e.g., based on the size and shape of the particle and known geometric relations). Likewise, the mass average particle size can be converted to the number average particle size and/or the volume average particle size, and the volume average particle size can be converted to the number average particle size and/or the mass average particle size using known methods. As used herein, unless context clearly dictates otherwise, the average particle size refers to the volume average particle size determined using screening.

The elemental powder can, for example, comprise a plurality of particles having an average particle size of 5 micrometers (μm) or more (e.g., 10 μm or more, 15 μm or more, 20 μm or more, 25 μm or more, 30 μm or more, 35 μm or more, 40 μm or more, 45 μm or more, 50 μm or more, 55 μm or more, 60 μm or more, 65 μm or more, 70 μm or more, 75 μm or more, 80 μm or more, 85 μm or more, 90 μm or more, or 95 μm or more). In some examples, the elemental powder can comprise a plurality of particles having an average particle size of 100 μm or less (e.g., 95 μm or less, 90 μm or less, 85 μm or less, 80 μm or less, 75 μm or less, 70 μm or less, 65 μm or less, 60 μm or less, 55 μm or less, 50 μm or less, 45 μm or less, 40 μm or less, 35 μm or less, 30 μm or less, 25 μm or less, 20 μm or less, 15 μm or less, or 10 μm or less). The average particle size of the plurality of particles comprising the elemental powder can range from any of the minimum values described above to any of the maximum values described above. For example, the elemental powder can comprise a plurality of particles having an average particles size of from 5 μm to 100 μm (e.g., from 5 μm to 50 μm, from 50 μm to 100 μm, from 5 μm to 20 μm, from 20 μm to 40 μm, from 40 μm to 60 μm, from 60 μm to 80 μm, from 80 μm to 100 μm, or from 5 μm to 70 μm).

The second powder can, for example, comprise a metal, a semimetal, a nonmetal, or a combination thereof. In some examples, the second powder can be a compound comprising a metal, a semimetal, a nonmetal, or a combination thereof. In some examples, the second powder can include more than one powder (e.g., the second powder can be a mixture of one or more powders). In some examples, the second powder can comprise Be, B, C, Mg, Al, Si, P, S, Ca, Sc, Ti, V, Cr, Mn, Fe, Co, Ni, Cu, Zn, Ga, Ge, As, Se, Sr, Y, Zr, Nb, Mo, Tc, Ru, Rh, Pd, Ag, Cd, In, Sn, Sb, Te, Ba, Hf, Ta, W, Re, Os, Ir, Pt, Au, Hg, Tl, Pb, Bi, Po, La, Ce, Pr, Nd, Pm, Sm, Eu, Gd, Tb, Dy, Ho, Er, Tm, Yb, or a combination thereof.

The second powder can, for example, comprise a plurality of particles having an average particle size of 5 micrometers (μm) or more (e.g., 10 μm or more, 15 μm or more, 20 μm or more, 25 μm or more, 30 μm or more, 35 μm or more, 40 μm or more, 45 μm or more, 50 μm or more, 55 μm or more, 60 μm or more, 65 μm or more, 70 μm or more, 75 μm or more, 80 μm or more, 85 μm or more, 90 μm or more, or 95 μm or more). In some examples, the second powder can comprise a plurality of particles having an average particle size of 100 μm or less (e.g., 95 μm or less, 90 μm or less, 85 μm or less, 80 μm or less, 75 μm or less, 70 μm or less, 65 μm or less, 60 μm or less, 55 μm or less, 50 μm or less, 45 μm or less, 40 μm or less, 35 μm or less, 30 μm or less, 25 μm or less, 20 μm or less, 15 μm or less, or 10 μm or less). The average particle size of the plurality of particles comprising the second powder can range from any of the minimum values described above to any of the maximum values described above. For example, the second powder can comprise a plurality of particles having an average particles size of from 5 μm to 100 μm (e.g., from 5 μm to 50 μm, from 50 μm to 100 μm, from 5 μm to 20 μm, from 20 μm to 40 μm, from 40 μm to 60 μm, from 60 μm to 80 μm, from 80 μm to 100 μm, or from 5 μm to 70 μm).

In some examples, the second powder can comprise a second elemental powder. The second elemental powder can, for example, be of commercial purity. In some example, the second elemental powder can have an elemental purity of 99% or more (e.g., 99.1% or more, 99.2% or more, 99.3% or more, 99.4% or more, 99.5% or more, 99.6% or more, 99.7% or more, 99.8% or more, or 99.9% or more).

In some examples, the mixed powder can further comprise a third powder. The third powder can, for example, comprise a metal, a semimetal, a nonmetal, or a combination thereof. In some examples, the third powder can be a compound comprising a metal, a semimetal, a nonmetal, or a combination thereof. In some examples, the third powder can include more than one powder (e.g., the third powder can be a mixture of one or more powders). In some examples, the third powder can comprise Be, B, C, Mg, Al, Si, P, S, Ca, Sc, Ti, V, Cr, Mn, Fe, Co, Ni, Cu, Zn, Ga, Ge, As, Se, Sr, Y, Zr, Nb, Mo, Tc, Ru, Rh, Pd, Ag, Cd, In, Sn, Sb, Te, Ba, Hf, Ta, W, Re, Os, Ir, Pt, Au, Hg, Tl, Pb, Bi, Po, La, Ce, Pr, Nd, Pm, Sm, Eu, Gd, Tb, Dy, Ho, Er, Tm, Yb, or a combination thereof.

The third powder can, for example, comprise a plurality of particles having an average particle size of 5 micrometers (μm) or more (e.g., 10 μm or more, 15 μm or more, 20 μm or more, 25 μm or more, 30 μm or more, 35 μm or more, 40 μm or more, 45 μm or more, 50 μm or more, 55 μm or more, 60 μm or more, 65 μm or more, 70 μm or more, 75 μm or more, 80 μm or more, 85 μm or more, 90 μm or more, or 95 μm or more). In some examples, the third powder can comprise a plurality of particles having an average particle size of 100 μm or less (e.g., 95 μm or less, 90 μm or less, 85 μm or less, 80 μm or less, 75 μm or less, 70 μm or less, 65 μm or less, 60 μm or less, 55 μm or less, 50 μm or less, 45 μm or less, 40 μm or less, 35 μm or less, 30 μm or less, 25 μm or less, 20 μm or less, 15 μm or less, or 10 μm or less). The average particle size of the plurality of particles comprising the third powder can range from any of the minimum values described above to any of the maximum values described above. For example, the third powder can comprise a plurality of particles having an average particles size of from 5 μm to 100 μm (e.g., from 5 μm to 50 μm, from 50 μm to 100 μm, from 5 μm to 20 μm, from 20 μm to 40 μm, from 40 μm to 60 μm, from 60 μm to 80 μm, from 80 μm to 100 μm, or from 5 μm to 70 μm).

In some examples, the third powder can comprise a third elemental powder. The third elemental powder can, for example, be of commercial purity. In some examples, the third elemental powder can have an elemental purity of 99% or more (e.g., 99.1% or more, 99.2% or more, 99.3% or more, 99.4% or more, 99.5% or more, 99.6% or more, 99.7% or more, 99.8% or more, or 99.9% or more).

The method can, in some examples, further comprise forming the mixed powder. The mixed powder can be formed, for example, by mixing the elemental powder, the second powder, and, optionally, the third powder. Mixing can be accomplished by mechanical agitation, for example mechanical stirring, shaking, vortexing, sonication (e.g., bath sonication, probe sonication), grinding, milling (e.g., air-attrition milling (jet milling) or ball milling), and the like.

In some examples, producing the precursor workpiece on a layer-by-layer basis can further comprise melting at least a portion of the elemental powder in the layer by directing an energy field onto a portion of the layer of the mixed powder.

The energy field can, for example, comprise energy in the form of electromagnetic radiation, electron radiation, positron radiation, proton radiation, plasma radiation, ionic radiation, or a combination thereof.

In some examples, the energy field can comprise electromagnetic radiation at one or more wavelengths of 100 nm or more (e.g., 200 nm or more, 300 nm or more, 400 nm or more, 500 nm or more, 600 nm or more, 700 nm or more, 800 nm or more, 900 nm or more, 1000 nm or more, 5 μm or more, 10 μm or more, 15 μm or more, 20 μm or more, 30 μm or more, 40 μm or more, 50 μm or more, 100 μm or more, 200 μm or more, 300 μm or more, 400 μm or more, 500 μm or more, 1000 μm or more, 5 mm or more, 10 mm or more, 5 cm or more, 10 cm or more, 15 cm or more, 20 cm or more, 25 cm or more, 50 cm or more, or 75 cm or more). In some examples, the energy field can comprise electromagnetic radiation at one or more wavelengths of 1 m or less (e.g., 75 cm or less, 50 cm or less, 25 cm or less, 20 cm or less, 15 cm or less, 10 cm or less, 5 cm or less, 10 mm or less, 5 mm or less, 1000 μm or less, 500 μm or less, 400 μm or less, 300 μm or less, 200 μm or less, 100 μm or less, 50 μm or less, 40 μm or less, 30 μm or less, 20 μm or less, 15 μm or less, 10 μm or less, 5 μm or less, 1000 nm or less, 900 nm or less, 800 nm or less, 700 nm or less, 600 nm or less, 500 nm or less, 400 nm or less, 300 nm or less, or 200 nm or less). The one or more wavelengths of electromagnetic radiation of the energy field can range from any of the minimum values described above to any of the maximum values described above. For example, the energy field can comprise electromagnetic radiation at one or more wavelengths of from 100 nm to 1 m (e.g., from 100 nm to 50 cm, from 50 cm to 1 m, from 100 nm to 1000 nm, from 1000 nm to 100 μm, from 100 μm to 1000 μm, from 1000 μm to 10 mm, from 10 mm to 1 m, or from 300 nm to 1000 nm).

The power, energy density, scan speed, or a combination thereof of the energy field can be selected in view of a variety of factors. In some examples, the power, energy density, scan speed, or a combination thereof of the energy field can be selected to minimize the fabrication time of the precursor workpiece while maximizing the mechanical properties of the precursor workpiece.

The energy field can, for example, have a power of 20 Watts or more (e.g., 30 Watts or more, 40 Watts or more, 50 Watts or more, 60 Watts or more, 70 Watts or more, 80 Watts or more, 90 Watts or more, 100 Watts or more, 150 Watts or more, 200 Watts or more, 250 Watts or more, 300 Watts or more, 350 Watts or more, 400 Watts or more, 450 Watts or more, 500 Watts or more, 600 Watts or more, 700 Watts or more, 800 Watts or more, or 900 Watts or more). In some examples, the energy field can have a power of 1000 Watts or less (e.g., 900 Watts or less, 800 Watts or less, 700 Watts or less, 600 Watts or less, 500 Watts or less, 450 Watts or less, 400 Watts or less, 350 Watts or less, 300 Watts or less, 250 Watts or less, 200 Watts or less, 150 Watts or less, 100 Watts or less, 90 Watts or less, 80 Watts or less, 70 Watts or less, 60 Watts or less, 50 Watts or less, 40 Watts or less, or 30 Watts or less). The power of the energy field can range from any of the minimum values described above to any of the maximum values described above. For example, the energy field can have a power of from 20 Watts to 1000 Watts (e.g., from 20 Watts to 500 Watts, from 500 Watts to 1000 Watts, from 20 Watts to 200 Watts, from 200 Watts to 400 Watts, from 400 Watts to 600 Watts, from 600 Watts to 800 Watts, from 800 Watts to 1000 Watts, or from 200 Watts to 500 Watts).

The energy field can, for example, have a power density of 300 J/cm² or more (e.g., 400 J/cm² or more, 500 J/cm² or more, 600 J/cm² or more, 700 J/cm² or more, 800 J/cm² or more, 900 J/cm² or more, 1000 J/cm² or more, 1250 J/cm² or more, 1500 J/cm² or more, 1750 J/cm² or more, 2000 J/cm² or more, 2250 J/cm² or more, 2500 J/cm² or more, 3000 J/cm² or more, 3500 J/cm² or more, 4000 J/cm² or more, or 4500 J/cm² or more). In some examples, the energy field can have a power density of 5000 J/cm² or less (e.g., 4500 J/cm² or less, 4000 J/cm² or less, 3500 J/cm² or less, 3000 J/cm² or less, 2500 J/cm² or less, 2250 J/cm² or less, 2000 J/cm² or less, 1750 J/cm² or less, 1500 J/cm² or less, 1250 J/cm² or less, 1000 J/cm² or less, 900 J/cm² or less, 800 J/cm² or less, 700 J/cm² or less, 600 J/cm² or less, 500 J/cm² or less, or 400 J/cm² or less). The power density of the energy field can range from any of the minimum values described above to any of the maximum values described above. For example, the energy field can have a power density of from 300 J/cm² to 5000 J/cm² (e.g., from 300 J/cm² to 2500 J/cm², from 2500 J/cm² to 5000 J/cm², from 300 J/cm² to 1000 J/cm², from 1000 J/cm² to 2000 J/cm², from 2000 J/cm² to 3000 J/cm², from 3000 J/cm² to 4000 J/cm², from 4000 J/cm² to 5000 J/cm², or from 500 J/cm² to 4500 J/cm²).

In some examples, the energy field can have a scan speed of 1 millimeter per second (mm/s) or more (e.g., 5 mm/s or more, 10 mm/s or more, 15 mm/s or more, 20 mm/s or more, 25 mm/s or more, 50 mm/s or more, 75 mm/s or more, 100 mm/s or more, 150 mm/s or more, 200 mm/s or more, 250 mm/s or more, 300 mm/s or more, 350 mm/s or more, 400 mm/s or more, 450 mm/s or more, 500 mm/s or more, 600 mm/s or more, 700 mm/s or more, 800 mm/s or more, 900 mm/s or more, or 1000 mm/s or more). In some examples, the energy field can have a scan speed of 2 meters per second (m/s) or less (e.g., 1000 mm/s or less, 900 mm/s or less, 800 mm/s or less, 700 mm/s or less, 600 mm/s or less, 500 mm/s or less, 450 mm/s or less, 400 mm/s or less, 350 mm/s or less, 300 mm/s or less, 250 mm/s or less, 200 mm/s or less, 150 mm/s or less, 100 mm/s or less, 75 mm/s or less, 50 mm/s or less, 25 mm/s or less, 20 mm/s or less, 15 mm/s or less, 10 mm/s or less, or 5 mm/s or less). The scan speed of the energy field can range from any of the minimum values described above to any of the maximum values described above. For example, the energy field can have a scan speed of from 1 mm/s to 2 m/s (e.g., from 1 mm/s to 500 mm/s, from 500 mm/s to 2 m/s, from 1 mm/s to 200 mm/s, from 200 mm/s to 400 mm/s, from 400 mm/s to 600 mm/s, from 600 mm/s to 800 mm/s, from 800 mm/s to 2 m/s, from 75 mm/s to 800 mm/s, or from 100 mm/s to 500 mm/s).

The energy field, for example, can be directed onto the portion of the layer of the mixed powder for an amount of time of 10 milliseconds (ms) or more (e.g., 20 ms or more, 30 ms or more, 40 ms or more, 50 ms or more, 60 ms or more, 70 ms or more, 80 ms or more, or 90 ms or more). In some examples, the energy field can be directed onto the portion of the layer of the mixed powder for an amount of time of 100 ms or less (e.g., 90 ms or less, 80 ms or less, 70 ms or less, 60 ms or less, 50 ms or less, 40 ms or less, 30 ms or less, or 20 ms or less). The amount of time for which the energy field is directed onto the portion of the layer of the mixed powder can range from any of the minimum values described above to any of the maximum values described above. For example, the energy field can be directed onto the portion of the layer of the mixed powder for an amount of time of from 10 ms to 100 ms (e.g., from 10 ms to 50 ms, from 50 ms to 100 ms, from 10 ms to 30 ms, from 30 ms to 50 ms, from 50 ms to 70 ms, from 70 ms to 100 ms, or from 20 ms to 90 ms).

In some examples, the energy field can be focused such that the energy field comprises an energy beam. Examples of energy beams include, but are not limited to, electromagnetic beams, charged particle beams, non-charged particle beams, and combinations thereof. In some examples, the energy beam can comprise a laser beam, a microwave beam, an electron beam, an ion beam, a plasma beam, or a combination thereof.

The energy beam can, for example, have a spot size which, as used herein, can be the diameter of the energy beam where the energy beam is directed onto the portion of the layer of the mixed powder. The spot size of the energy beam can be, for example, 50 μm or more (e.g., 75 μm or more, 100 μm or more, 150 μm or more, 200 μm or more, 250 μm or more, 300 μm or more, 350 μm or more, 400 μm or more, 450 μm or more, 500 μm or more, 600 μm or more, 700 μm or more, 800 μm or more, or 900 μm or more). In some examples, the spot size of the energy beam can be 1 mm or less (e.g., 900 μm or less, 800 μm or less, 700 μm or less, 600 μm or less, 500 μm or less, 450 μm or less, 400 μm or less, 350 μm or less, 300 μm or less, 250 μm or less, 200 μm or less, 150 μm or less, 100 μm or less, or 75 μm or less). The spot size of the energy beam can range from any of the minimum values described above to any of the maximum values described above. For example, the spot size of the energy beam can be from 50 μm to 1 mm (e.g., from 50 μm to 500 μm, from 500 μm to 1 mm, from 50 μm to 250 μm, from 250 μm to 500 μm, from 500 μm to 700 μm, from 700 μm to 1 mm, or from 100 μm to 500 μm).

Producing the precursor workpiece on a layer-by-layer basis can further comprise repeating the deposing and melting steps to form the precursor workpiece from a plurality of layers. The precursor workpiece can, for example, comprise a dispersed phase and a continuous phase, the dispersed phase being dispersed within the continuous phase, the dispersed phase comprising a plurality of discrete regions comprising the second powder, and the continuous phase comprising the melted elemental powder.

“Phase,” as used herein, generally refers to a region of a material having a substantially uniform composition which is a distinct and physically separate portion of a heterogeneous system. The term “phase” does not imply that the material making up a phase is a chemically pure substance, but merely that the chemical and/or physical properties of the material making up the phase are essentially uniform throughout the material, and that these chemical and/or physical properties differ significantly from the chemical and/or physical properties of another phase within the material. Examples of physical properties include density, thickness, aspect ratio, specific surface area, porosity and dimensionality. Examples of chemical properties include chemical composition.

“Continuous,” as used herein, generally refers to a phase such that all points within the phase are directly connected, so that for any two points within a continuous phase, there exists a path which connects the two points without leaving the phase.

In some examples, the methods can further comprise heating the precursor workpiece to homogenize the continuous phase and the dispersed phase, thereby forming the three-dimensional alloy workpiece comprising a continuous alloy phase.

Heating the precursor workpiece can, for example, comprise heating at a temperature of 50° C. or more (e.g., 100° C. or more, 150° C. or more, 200° C. or more, 250° C. or more, 300° C. or more, 350° C. or more, 400° C. or more, 450° C. or more, 500° C. or more, 550° C. or more, 600° C. or more, 650° C. or more, 700° C. or more, or 750° C. or more). In some examples, heating the precursor workpiece can comprise heating at a temperature of 800° C. or less (e.g., 750° C. or less, 700° C. or less, 650° C. or less, 600° C. or less, 550° C. or less, 500° C. or less, 450° C. or less, 400° C. or less, 350° C. or less, 300° C. or less, 250° C. or less, 200° C. or less, 150° C. or less, or 100° C. or less). The temperature at which the precursor workpiece is heated can range from any of the minimum values described above to any of the maximum values described above. For example, heating the precursor workpiece can comprise heating at a temperature of from 50° C. to 800° C. (e.g., from 50° C. to 400° C., from 400° C. to 800° C., from 50° C. to 200° C., from 200° C. to 350° C., from 350° C. to 500° C., from 500° C. to 650° C., from 650° C. to 800° C., or from 150° C. to 500° C.).

The precursor workpiece can be heated, for example, for an amount of time of 10 minutes or more (e.g., 15 minutes or more, 20 minutes or more, 25 minutes or more, 30 minutes or more, 35 minutes or more, 40 minutes or more, 45 minutes or more, 50 minutes or more, 55 minutes or more, 60 minutes or more, 70 minutes or more, 80 minutes or more, 90 minutes or more, 100 minutes or more, or 110 minutes or more). In some examples, the precursor workpiece can be heated for an amount of time of 2 hours or less (e.g., 110 minutes or less, 100 minutes or less, 90 minutes or less, 80 minutes or less, 70 minutes or less, 60 minutes or less, 55 minutes or less, 50 minutes or less, 45 minutes or less, 40 minutes or less, 35 minutes or less, 30 minutes or less, 25 minutes or less, 20 minutes or less, or 15 minutes or less). The amount of time for which the precursor workpiece is heated can range from any of the minimum values described above to any of the maximum values described above. For example, the precursor workpiece can be heated for an amount of time of from 10 minutes to 2 hours (e.g., from 10 minutes to 60 minutes, from 60 minutes to 2 hours, from 10 minutes to 30 minutes, from 30 minutes to 60 minutes, from 60 minutes to 90 minutes, from 90 minutes to 2 hours, or from 20 minutes to 1 hour).

The continuous alloy phase can comprise an alloy that is difficult to process using traditional additive manufacturing, for example an alloy that is prone to cracking and/or coring when a pre-alloyed powder is used in traditional additive manufacturing of the three dimensional workpiece. Such alloys are typically also difficult to weld, or have a low weldability. The International Organization for Standardization (ISO) defines weldability in ISO standard 581-1980 as: “Metallic material is considered to be susceptible to welding to an established extent with given processes and for given purposes when welding provides metal integrity by a corresponding technological process for welded parts to meet technical requirements as to their own qualities as well as to their influence on a structure they form.”

The continuous alloy phase can, for example, comprise an aluminum alloy, a copper alloy, a titanium alloy, a magnesium alloy, a nickel alloy, a lead alloy, a zinc alloy, a stainless steel alloy, or a combination thereof. In some examples, the continuous alloy phase can comprise an off-eutectic alloy.

The methods described herein can be implemented on a variety of additive manufacturing platforms, as known in the art. In some example, the additive manufacturing platform can include a build stage. In some examples, the methods can further comprise heating a build stage having a surface in contact with the layer of the mixed powder at a temperature less than the melting temperature of the mixed powder. In some examples, the build stage can be heated at a temperature of 25° C. or more (e.g., 30° C. or more, 35° C. or more, 40° C. or more, 45° C. or more, 50° C. or more, 60° C. or more, 70° C. or more, 80° C. or more, 90° C. or more, 100° C. or more, 150° C. or more, 200° C. or more, 250° C. or more, 300° C. or more, 350° C. or more, 400° C. or more, 450° C. or more, 500° C. or more, 550° C. or more, 600° C. or more, 650° C. or more, 700° C. or more, or 750° C. or more). In some examples, the build stage can be heated at a temperature of 800° C. or less (e.g., 750° C. or less, 700° C. or less, 650° C. or less, 600° C. or less, 550° C. or less, 500° C. or less, 450° C. or less, 400° C. or less, 350° C. or less, 300° C. or less, 250° C. or less, 200° C. or less, 150° C. or less, 100° C. or less, 90° C. or less, 80° C. or less, 70° C. or less, 60° C. or less, 50° C. or less, 45° C. or less, 40° C. or less, 35° C. or less, or 30° C. or less). The temperature at which the build stage is heated can range from any of the minimum values described above to any of the maximum values described above. For example, the build stage can be heated at a temperature of from 25° C. to 800° C. (e.g., 25° C. to 400° C., from 400° C. to 800° C., from 25° C. to 200° C., from 200° C. to 400° C., from 400° C. to 600° C., from 600° C. to 800° C., or from 35° C. to 750° C.).

The examples below are intended to further illustrate certain aspects of the methods and compounds described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

### Example 1

Aluminum 6061 is of commercial interest due to its ubiquitous use in manufacturing, advantageous mechanical properties, and its successful certification in aerospace applications. However, as an off-eutectic with accompanying large freezing range, attempts to process the material by additive manufacturing have resulted in part cracking and diminished mechanical properties.

The primary feedstock for laser based additive manufacturing remains pre-alloyed powder or wire. A method of in situ alloying of near-eutectic AlSi12 to reduce residual stress in anchorless selective laser melting has been investigated by utilizing the melting point depression of eutectic alloys to form a “super cooling” like behavior (Vora P et al. Addit. Manuf. 2015, 7, 12-19). To date, research has not been done focusing on utilizing elemental mixtures to ease the processing of materials that are difficult to process using traditional additive manufacturing techniques. Furthermore, success has been limited in additive manufacturing processing and traditional powder metallurgy of hypoeutectic aluminum alloys (Gu D D et al. Int. Mater. Rev. 2012, 57, 133-164; Mosher W G et al. Powder Metall. 2011, 54, 432-439). In contrast, current research into the use of pure metals in selective laser melting has been successful for titanium, copper, gold, and magnesium systems (Becker D and Wissenbach K. 2009. Additive Manufacturing of Copper Components with Selective Laser Melting, Fraunhofer ILT Annual Report. Aachen Germany; Chung Ng C et al. Rapid Prototyp. J. 2011, 17, 479-490; Gu D et al. Acta Mater. 2012, 60, 3849-3860; Gu D D et al. Int. Mater. Rev. 2012, 57, 133-164; Khan M and Dickens P. Gold Bull. 2010, 43, 114-121).

Discussed herein is an approach to additive manufacturing processing of metal alloys by processing elemental powders followed by homogenization post-processing. This approach using mixed powders is presented to process historically difficult-to-process materials. Expansion of this combined-powder approach to other materials systems not typically compatible with additive manufacturing is possible. Dense parts without solidification cracking have been produced by the selective laser melting process discussed herein, as verified using scanning electron microscopy (SEM) and energy dispersive X-ray spectroscopy (EDS). An overview of this approach is presented along with test results using an Al—Si mixture.

To process off-eutectic metals, an elemental mixture of aluminum and silicon powders was utilized to mimic the final composition of AA6061. The use of magnesium or magnesium silicide powder was avoided in this initial analysis due to safety concerns and the reduced effect magnesium has on alloy melt range (10 K at 1.0 wt. % Mg) compared to silicon (70 K at 0.6 wt. % Si). Due to the relatively high melting point of silicon compared to aluminum, low build chamber temperature, and the short thermal cycle during the laser scan, the silicon can remain in the solid state without long range diffusion into the surrounding aluminum. Thus, the aluminum can melt and encapsulate the silicon particles. Post-selective laser melting homogenization treatment can then have the dual advantage of relieving residual stress and dissolving the silicon throughout the aluminum matrix. Since any pure metal melts congruently, the challenges associated with hot tearing due to solidification in the mushy zone can be negated with this method. Thereby, a major issue presented by hypoeutectic alloys during additive manufacturing powder bed processing can be overcome.

To better understand conditions that result in solidification cracks and to determine the effect of processing parameters on crack formation, an initial build was conducted utilizing pre-alloyed AA6061. Subsequently, during the first build stage utilizing an elemental mixture, dissolution of the silicon into the aluminum matrix was a primary concern. To assess the feasibility of this approach, a powder mixture was prepared with 0.6% silicon powder and 99.4% aluminum powder, which was processed using selective laser melting and then post-processed to dissociate the Si phase.

Initial feedstock for the elemental powder study was −325 mesh aluminum and silicon powder. The aluminum feedstock was obtained from Valemet and was comprised of substantially spherical atomized powder, as seen in Error! Reference source not found. 1, with a minimum purity of 99.7%. The silicon powder, obtained from Alfa Aesar with a purity of 99.5%, exhibited a highly faceted surface structure which a mean particle size of approximately 4 μm, as shown in FIG. 2. The powders were combined in a weight fraction of 99.4% Al-0.6% Si and then mixed on medium speed for 5 hours utilizing a U.S. Stoneware 802CVM ball mill with no additional media. The particle size distribution (PSD) for the mixed powder and comparison feedstocks were analyzed using a MicroTrac 53500, with a volumetric-mean particle size of 35.49 μm and a standard deviation of 15.45 μm. Shear cell analysis using a FT-4 Powder Rhometer indicated good comparison to commercially available additive manufacturing powders, as shown in FIG. 3.

All samples were processed at Stratasys Direct Manufacturing (SDM), Belton Tex. USA, using an EOSINT M280 powder bed fusion machine at a build temperature of 35° C. The maximum laser power output from the M280 was 370 W. Samples were prepared in test cubes as shown in FIG. 4. This square solid geometry of 8 mm by 8 mm by 3 mm allows up to four samples to be placed in a standard 31.8 mm diameter metallographic polishing puck. Given this geometry and the parameters used, each sample was comprised of approximately 75 build layers and between 40-100 scan tracks per layer.

The initial build utilized an AA6061 pre-alloyed powder. To determine the effects of laser power, scan speed, and scan spacing on the as-built microstructure, a large spread of processing parameters was employed based upon effective energy density and thermal properties of AA6061. Each as-built sample was ranked based upon surface finish, porosity, and crack density. From this data set, a parameter matrix consisting of 14 parameter sets, shown in Table 1, was developed for the build utilizing the elemental mixture of aluminum and silicon. A correction was made for the increased melting temperature of the pure aluminum (660° C.) as compared to the melting temperature of AA6061 (582-652° C.), resulting in an increase of the average energy input by 6.1% compared to the AA6061 results. Additional samples were created utilizing expanded parameters based on the optimal AA6061 results.

TABLE 1
Additive manufacturing parameter set for the Al—Si
elemental powder selective laser melting run.

| Sample | Beam Power | Scan Speed | Average Energy |
|---|---|---|---|
| Number | (W) | (mm/s) | (J/cm²) |
| 1 | 313 | 750 | 516 |
| 2 | 370 | 544 | 840 |
| 3 | 258 | 375 | 848 |
| 4 | 335 | 375 | 3157 |
| 5 | 192 | 75 | 4107 |
| 6 | 250 | 75 | 1459 |
| 7 | 222 | 187.5 | 1898 |
| 8 | 288 | 187.5 | 645 |
| 9 | 284 | 544 | 1155 |
| 10 | 351 | 375 | 1051 |
| 11 | 367 | 375 | 525 |
| 12 | 319 | 375 | 854 |
| 13 | 370 | 870 | 516 |
| 14 | 301 | 435 | 840 |

After selective laser melting additive manufacturing processing, each sample was sectioned on a low speed diamond saw, cleaned with warm water and ethyl alcohol, then placed in a 31.8 mm diameter mount and encapsulated in epoxy. Each sample was ground and polished using an automated rotary polisher in the following sequence: 500 and 1200 grit SiC paper immersed in water, followed by 9 μm, 3 μm, and 1 μm diamond suspension. Selected samples then underwent final polishing utilizing a 0.04 μm colloidal silica solution.

Heat treatment was used to promote diffusion of the silicon throughout the aluminum matrix. Solutionizing times were estimated using random walk analysis, resulting in a diffusion time of approximately 20 minutes. To ensure complete dissolution, samples were heat treated in a furnace at 600° C. for approximately 1 hour. To reduce complexity and cost, an inert environment was not utilized, as the solutionizing time was small which can inhibit long range diffusion of oxygen, resulting in only a thin surface oxide layer. Heat treated samples were sectioned and polished using the same procedure described above.

A range of techniques were utilized to analyze the samples. Prior to sectioning and polishing, images were taken of the top surfaces using a JEOL JSM-5610 scanning electron microscope (SEM). Each sample was qualitatively ranked on surface roughness and crack density while any apparent porosity was noted. After cross-sectioning and polishing, each sample was imaged using a Nikon Eclipse ME600 optical microscope with bright and dark field imaging to investigate the presence of cracks and internal porosity. SEM imaging was also performed on certain cross-sectioned samples to determine locations of silicon particles and any additional porosity not seen during optical analysis. Energy-dispersive X-ray spectroscopy (EDS) was performed to determine silicon particle spatial distribution and size on both as-built and heat treated samples. Sample areas were scanned for approximately 10 minutes for data gathering.

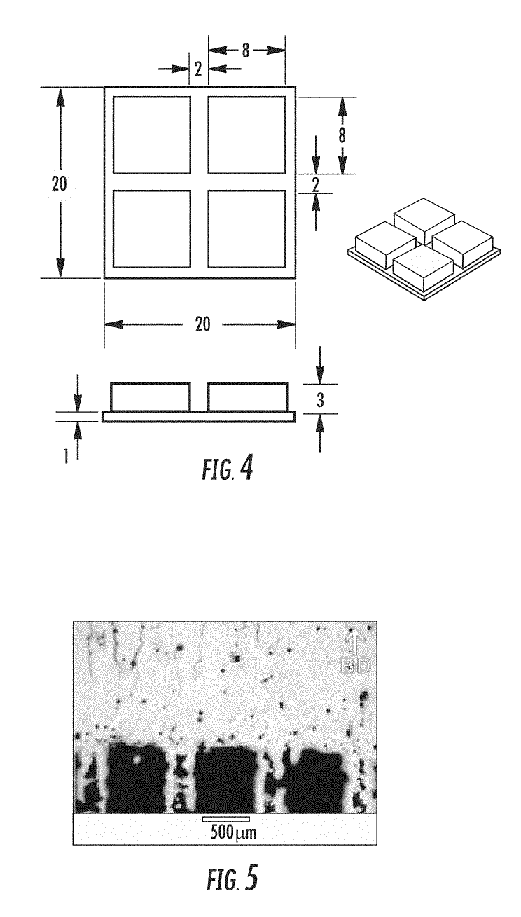

Selective laser melting samples of the pre-alloyed AA6061 without post-processing showed evidence of severe cracking throughout. Scan spacing had little effect on final properties; however, laser power and scan speed had an effect on the initial specimen quality. Moderate laser power and scan speed yielded samples with optimal results. Upon metallographic analysis, both average void size and crack density were reduced in the region encompassing approximately 0.75 mm above the support structures, as shown in FIG. 5. Large thermal gradients are believed to have contributed to crack formation. For the first 500 μm of sample height, there is relatively slow cooling due to the poor thermal conductivity of the supporting powder and sparse support structure. As the solid part height increases, the capacity of the underlying material to extract heat from the melt pool increases, resulting in steeper thermal gradients and larger thermal stresses.

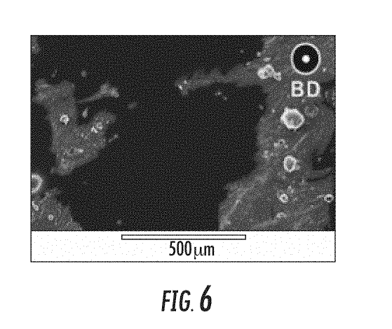

Unexpectedly, dark pools were observed on specimen surfaces, shown in FIG. 6. EDS analysis indicated that the pools were associated with an increase in magnesium, carbon, and oxygen content. This is also suggested by the dark shading shown in the secondary electron images, which have a backscatter electron component where lower atomic number elements show up as dark regions compared to the neighboring elements (e.g., Mg vs. Al). Segregation of magnesium is likely caused by either the relatively low density of magnesium compared to aluminum resulting in buoyancy-driven flow, segregation-driven flow in the mushy zone due to non-equilibrium solidification, Marangoni flow related phenomena, or some combination thereof. Often these pools were seen near crack formation or on the inside of the crack itself. Furthermore, a decrease in magnesium pool size at higher laser powers was observed. Laser welding research suggests that high power levels can cause vaporization of magnesium from the melt pool, which can decrease the melt pool size.

The as-processed blended Al—Si specimens varied greatly in both surface finish, and fusion defects. While the best surface finish was present at high laser power and slow scan speeds, SEM imaging showed the presence of defects for these samples, especially near the sample number embossed on the surface. Moderate laser power and medium to high scan speeds, similar to that obtained for the best AA6061 specimens, demonstrated optimal properties resulting in two of the samples having relatively low surface defect density at the cost of a slightly rougher surface finish, as shown in FIG. 7.

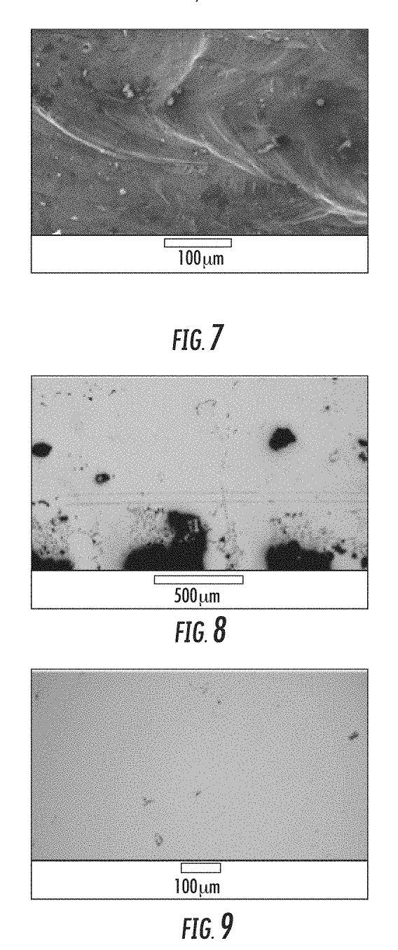

Optical analysis of the samples revealed a wide range of porosity, as shown in FIG. 8 and FIG. 9. Many samples showed porosity emanating from the support structures in straight lines, which would then be crossed by a perpendicular line of porosity of similar size, as evident in sample 12 shown in FIG. 8. This phenomenon is believed to be a result of processing conditions and not material dependent porosity related to the parameters in question.

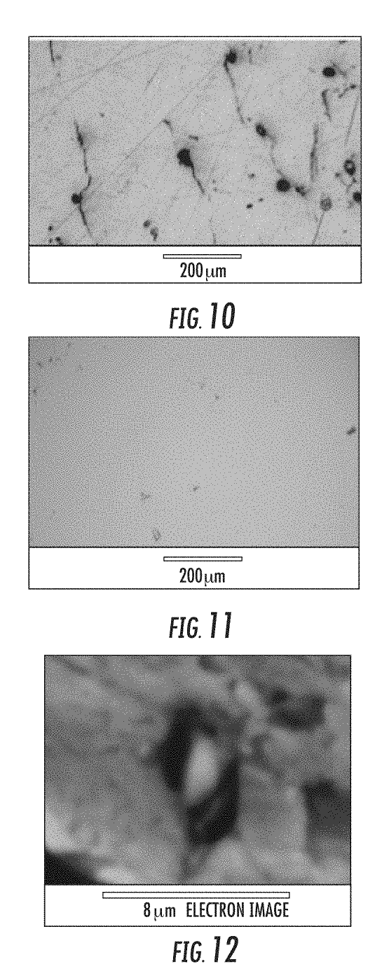

All samples showed improvement in crack formation and growth compared to AA6061, as illustrated by FIG. 10 and FIG. 11. An elemental mixture should behave much like that of the primary component as long all other constituents are relatively dilute. Thus, unlike the pre-alloyed AA6061 feedstock, the elemental mixture will exhibit nearly congruent melting resulting in a freezing point instead of a freezing zone. Therefore, thermal stresses are minimized and hot tearing can be avoided. This is evidenced by the lack of solidification cracking seen in the samples produced from the elemental mixture. The morphology of the defects that did appear suggested that the creation of the defect was due to inadequate fusion of the powder, which resulted in cracks that followed the outline of the particle boundaries upon cooling, versus hot tearing, where tendrils partially bridged the crack indicating that the crack formed while the material remained in the mushy state.

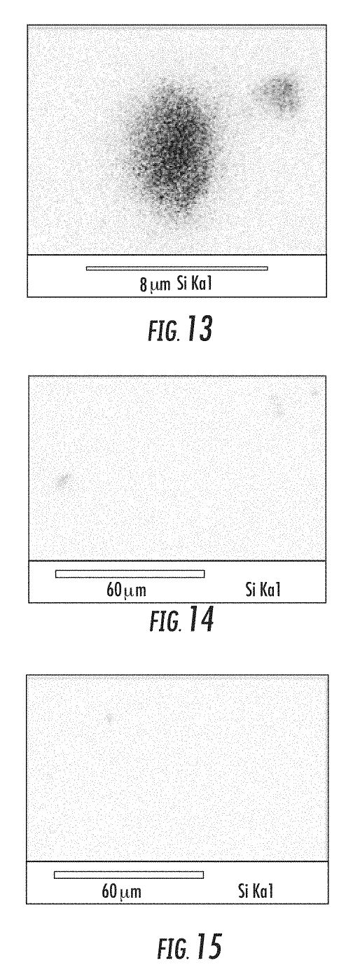

It is hypothesized that the silicon remains in the solid state throughout the selective laser melting processing of the elemental mixture due to its relatively high melting point and selective laser melting's short thermal cycling times. Therefore, Si particles of similar size and shape as the feedstock should be present in the as-built samples and should be dispersed in a nearly homogeneous distribution. The feedstock consisted of highly faceted silicon particles which had a size distribution of approximately 1-5 μm in diameter with a typical particle possessing a major axis length of approximately 4 μm. To determine the silicon distribution in the as-built samples, EDS was performed on Sample 9. Silicon particles within the image were then magnified and exposed again to determine the size of the particle. As shown in FIG. 12 and FIG. 13, silicon particles exhibited the predicted morphology, both highly faceted and approximately 4 μm in length along the major axis. This suggests that the silicon particles remained solid within the melt pool during selective laser melting, undergoing minimal dissolution into the surrounding aluminum matrix. Melting remained congruent, and coring was minimized as the melt pool consisted mainly of pure aluminum with trace impurities.

After heat treatment, there was a significant decrease in the observed number of silicon particles throughout the aluminum matrix, as shown in FIG. 14 and FIG. 15. However, a few small particles remained in certain samples. It is thought that these particles represented the upper range of the particle size distribution of the silicon particles. These particles reduced in size during the post-processing solutionizing anneal but did not completely dissolve due to inadequate time (1 hr) at this post-processing temperature (600° C.). A longer solutionizing time would further reduce their size and eventually result in complete dissolution. The solutionizing time was kept to a minimum in this study to reduce the oxidation of the surface of the part. By solutionizing the sample in a furnace open to the air, cost and complexity are reduced leading to a more economically viable process.

Elemental mixtures show promise in reducing and possibly eliminating solidification cracking in off-eutectic alloys. An aluminum silicon mixture was processed and shown to form an alloy after heat treatment. Optimal processing conditions for this example were shown to occur at moderate laser power and scan speed.

The methods and compositions of the appended claims are not limited in scope by the specific methods and compositions described herein, which are intended as illustrations of a few aspects of the claims and any methods and compositions that are functionally equivalent are within the scope of this disclosure. Various modifications of the methods and compositions in addition to those shown and described herein are intended to fall within the scope of the appended claims. Further, while only certain representative methods, compositions, and aspects of these methods and compositions are specifically described, other methods and compositions and combinations of various features of the methods and compositions are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

1. A method of producing a three-dimensional alloy workpiece using additive manufacturing the method comprising:
producing a precursor workpiece on a layer-by-layer basis by:
depositing a layer of a mixed powder, the mixed powder comprising an elemental powder and a second powder, wherein the elemental powder is present in the mixed powder in an amount of 50% or more by weight;
melting at least a portion of the elemental powder in the layer by directing an energy field onto a portion of the layer of the mixed powder; and
repeating the deposing and melting steps to form the precursor workpiece from a plurality of layers, the precursor workpiece comprising a dispersed phase and a continuous phase, the dispersed phase being dispersed within the continuous phase, the dispersed phase comprising a plurality of discrete regions comprising the second powder, and the continuous phase comprising the melted elemental powder; and
heating the precursor workpiece to homogenize the continuous phase and the dispersed phase, thereby forming the three-dimensional alloy workpiece comprising a continuous alloy phase.

2. The method of claim 1, further comprising forming the mixed powder by mixing the elemental powder and the second powder.

3. The method of claim 1, wherein the elemental powder is present in the mixed powder in an amount of 99% or more.

4. The method of claim 1, wherein the elemental powder comprises a metallic element with an elemental purity of 99% or more.

5. The method of claim 4, wherein the elemental powder comprises a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, and Yb.

6. The method of claim 5, wherein the elemental powder comprises a metal selected from the group consisting of Mg, Al, Ti, Fe, Ni, Cu, Zn, and Pb.

7. The method of claim 1, wherein the elemental powder consists of a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, and Yb.

8. The method of claim 7, wherein the elemental powder consists of a metal selected from the group consisting of Mg, Al, Ti, Fe, Ni, Cu, Zn, and Pb.

9. The method of claim 1, wherein the elemental powder consists essentially of a metal selected from the group consisting of Be, Mg, Al, Ca, Sc, Ti, V, Cr, Mn, Fe, Co, Ni, Cu, Zn, Ga, Sr, Y, Zr, Nb, Mo, Tc, Ru, Rh, Pd, Ag, Cd, In, Sn, Ba, Hf, Ta, W, Re, Os, Ir, Pt, Au, Hg, Tl, Pb, Bi, La, Ce, Pr, Nd, Pm, Sm, Eu, Gd, Tb, Dy, Ho, Er, Tm, and Yb.

10. The method of claim 9, wherein the elemental powder consists essentially of a metal selected from the group consisting of Mg, Al, Ti, Fe, Ni, Cu, Zn, and Pb.

11. The method of claim 1, wherein the elemental powder comprises a plurality of particles having an average particle size of from 5 micrometers (μm) to 100 μm.

12. The method of claim 1, wherein the second powder comprises a metal, a semimetal, a nonmetal, or a combination thereof.

13. The method of claim 12, wherein the second powder comprises Be, B, C, Mg, Al, Si, P, S, Ca, Sc, Ti, V, Cr, Mn, Fe, Co, Ni, Cu, Zn, Ga, Ge, As, Se, Sr, Y, Zr, Nb, Mo, Tc, Ru, Rh, Pd, Ag, Cd, In, Sn, Sb, Te, Ba, Hf, Ta, W, Re, Os, Ir, Pt, Au, Hg, Tl, Pb, Bi, Po, La, Ce, Pr, Nd, Pm, Sm, Eu, Gd, Tb, Dy, Ho, Er, Tm, Yb, or a combination thereof.

14. The method of claim 1, wherein the second powder comprises a second elemental powder with an elemental purity of 99% or more.

15. The method of claim 1, wherein the second powder comprises a plurality of particles having an average particle size of from 5 micrometers (μm) to 100 μm.

16. The method of claim 1, wherein the alloy phase comprises an aluminum alloy, a copper alloy, a titanium alloy, a magnesium alloy, a nickel alloy, a lead alloy, a zinc alloy, a stainless steel alloy, or a combination thereof.

17. The method of claim 1, wherein the alloy phase comprises an off-eutectic alloy.

18. The method of claim 1, wherein the energy field comprises an energy beam.

19. The method of claim 18, wherein the energy beam comprises a laser beam.

20. The method of claim 1, wherein heating the precursor workpiece comprises heating at a temperature of from 50° C. to 800° C.

21. The method of claim 20, wherein heating the precursor workpiece comprises heating at a temperature of from 150° C. to 500° C.

22. The method of claim 1, wherein the precursor workpiece is heated for an amount of time of from 10 minutes to 2 hours.

23. The method of claim 22, wherein the precursor workpiece is heated for an amount of time of from 20 minutes to 1 hour.
